(19) United States
(12) Patent Application Publication
(10) Pub. No.: US 2010/0112374 A1
(43) Pub. Date: May 6, 2010

(54) MATERIAL AND METHOD FOR COATING A SURFACE

(75) Inventor: Peter Knauf, Dusseldorf (DE)

Correspondence Address: WOLF GREENFIELD & SACKS, P.C., 600 ATLANTIC AVENUE, BOSTON, MA, 02210-2206, US

(73) Assignee: Durum Verschleiss-Schutz GmbH, Willich-Schiefbahn (DE)

(21) Appl. No.: 12/596,237

(22) PCT Filed: Apr. 21, 2008
(86) PCT No.: PCT/EP08/03175

§ 371 Date: Oct. 16, 2009

(30) Foreign Application Priority Data
Apr. 20, 2007 (DE) 10 2007 019 150.4

(51) Int. Cl. B32B 15/04; C09D 1/00; B23K 9/04

(52) U.S. Cl. 428/615; 106/286.3; 106/286.1; 219/76.14

(57) ABSTRACT

The invention relates to a material for coating a surface by means of at least partial thermal phase change, comprising a first component with several metal ingredients to form a matrix, ans a second component to form a hard phase embedded in the matrix, wherein the first component, based on the total weight thereof, has a fraction of at least about 40% nickel and the second component is a fraction based on the total weight of the material between about 20% and about 80% and the first component, based on the total weight thereof, has a fraction of at least about 10%, in particular, at least about 20% of a further metal from the group of copper or iron.

The present invention relates to a material for the coating of a surface according to the preamble of claim 1. Die invention further relates to a procedure for the coating of a surface according to the features of claim 64.

It is known in the art to provide technical surfaces with functional coatings in order to improve protection against wear. Examples for such items are bottom plates for caterpillar- or tracklaying vehicles, in particular in the field of open pit mining, active areas of rock crushers, shovels and blades for graders, caterpillars and tracklaying vehicles, drill heads and much more. Typical applications of such wear-resistance coatings are mines, open pit mines and earthworks, deep drilling (in particular for exploration of oil and gas) and tunneling. Further, not limiting examples for the application purpose are cement- and brick industry as well as recycling-industry.

DE 40 08 091 C2 describes an electrode from a material for the application of a wear-resistant coating with a matrix consisting of a nickel alloy and embedded tungsten carbides for the deposition by means of arc welding. Thereby nickel is used as the major component of the matrix.

It is further known in the art to use similar electrodes with an iron-based matrix component, wherein an iron-matrix does not provide useful results when deposited by means of arc welding. The high temperature of arc welding causes, in the connection with iron, a predominant melting of the tungsten carbides formed as particles.

It is the object of the invention to provide an initially mentioned material for the particularly metallic coating of a surface, which, under provision of a good wear-resistance, is cost effective in relation to known materials with a nickel-based matrix.

This object is achieved for the initially mentioned material by the characterizing features of claim 1.

All of the herein stated percentages of a substance portion are to be understood as weight-percent. By the significant portion of at least about 10% of either iron or copper in the first component of the material the necessyry portion of nickel can be reduced, in particular up to a share of only 40% of the first component. Therefore, with respect to conventional materials with nickel based matrix, a significant portion of nickel can be economized, the material still being suitable for deposition by means of arc welding. At present, the price for copper is only about a seventh of the nickel price, the price for iron being even far less.

The material according to the invention may be deposited by means of other deposition methods such as Laser Deposition Welding, Plasma Deposition Welding (PTA), or the like. Thereby, the material may be present as a powder or in other form, like for instance as a filler wire in some applications of Laser Deposition Welding.

In a preferred development of the invention, the second component has a share of between about 30% and about 70% of the total weight of the material, in particular between about 50% and about 65%. Such approximately half-by-half mixture of the first component (matrix) and the second component (hard phase) has proved to be particularly well suited for achieving a stable and wear resistant coating.

Further preferred the second component consists of a hard material, in particular a tungsten carbide. Particularly preferred the hard material is present in the material as a compound constituent in the form of particles, for example in the form of a broken or spherical two phase tungsten carbide. In particular the tungsten carbide can be present, respectively alternative or additional, as a sintered, molten and broken, spherical, macrocrystalline or cobalt-bound tungsten carbide in mixed, enveloped or agglomerated form. The basis is formed by the advantageous principle to firstly produce the hard material in its chemically, structurally and geometrically optimal form dependant on the respective application. This predetermined hard material, which provides the second component of the material, is then distributed in the coating in embedded in the re-solidifying matrix by means of melting or thermal phase changing the first component. Thereby the hard material at least partially keeps its properties, which have previously been provided by different, possibly elaborate manufacturing procedures.

In a particularly preferred embodiment of the invention, the hard material is at least partially, in particular predominantly present in the form of two phase tungsten carbide (WSC). Alternatively or additionally, the hard material is at least partially, in particular predominantly present in the form of macrocrystalline tungsten carbide. Thereby, in particular a mixture of WSC and macrocrystalline tungsten carbide can be provided.

Both appearances, WSC and macrocrystalline tungsten carbide, have the significant advantage, compared to a sintered form of tungsten carbide, that the particles are particularly stable during the processing, e.g. arc welding, and do not disintegrate or dissolve. According to the present invention this is particularly important at least in the case of significant amounts of iron being present in the first component, for example shares of iron of more than 35%. It has been shown by experiments that such high shares of iron, which on the other hand come up with a particular big advantage of cost reduction, are especially critical because of the temperatures occurring during the processing with respect to destruction (melting or dissolving) of particles of the second component.

In the case of an alternative or additional embodiment, the hard material is present at least partially as vanadium carbide in particle form. Vanadium carbide has a very high hardness and is well suited as a hard phase of the protective coating.

Generally, vanadium and carbon may be present in the material in order to generate vanadium carbide in the hard phase. The carbon may, for instance, be present in the form of graphite. In particular with the high temperatures of a deposition by means of arc welding, vanadium with presence of sufficient amounts of carbon has the advantage that, during cooling down, it precipitates in the form of spherical embeddings of vanadium carbide from a completely molten phase. With increasing cooling rate, the precipitated particles becomes increasingly smaller, it being possible to influence the properties of the protective coating with respect to size and distribution of the vanadium carbide particles by the framing parameters of the deposition procedure. If vanadium carbide is present as a pre-formed portion of the material, depending on the conditions of the deposition, either the pre-formed particle can be embedded into the matrix without phase transition or —at higher temperatures— it may firstly be completely molten and then crystallize as a particle from the cooling matrix as described above.

Basically any other known and suitable hard phase, in particular in the form of a pre-formed hard material, is applicable within a material according to the invention, for example chromium carbide, titanium carbide, niobium carbide, titanium boride or niobium boride.

Known and suitable procedures for the thermal phase transition, which occurs at least for the first component, are for example gas shielded metal arc welding (MSG), and particularly preferred arc welding. Further possible procedures are, without limitation, plasma-transferred-arc deposition, thermal spraying, arc-spraying, plasma-spraying, High Velocity Oxygen Fuel Spraying (HVOF) and/or gas dynamic cold spraying.

The coating building up on the surface is a compound layer, characterized according to the invention by the ratio of nickel on the one hand and iron and/or copper on the other hand in connection with a separate hard phase. According to the deposition procedure and further shares of metals, apart from the embedded, particularly pre-formed hard phases (hard material particles), further native hard phases may be present. The layer is characterized by a good corrosion resistance. The matrix phase of the deposited layer has, in pa preferred embodiment, a hardness of at least about 40 HRC, which in particular can be achieved in the case of high shares of copper. In the case of high shares of iron, depending on the composition a hardness of the matrix phase of more than 50 HRC can be achieved.

In a first preferred embodiment of a material according to the invention the weight portion of nickel in the first component is not more than about 70%, in particular between about 50% and about 70%. Most preferred, the weight portion of nickel is between about 60% and about 65%. Advantageously, the material thereby has a weight portion of copper in the first component of between about 20% and about 40%, in particular between about 30% and about 35%. Such embodiment, wherein a major share of copper is present with the nickel in the matrix, results in good anti-magnetic properties of the material. This makes the material particularly suitable for applications in which sensitive electronics is present in the proximity of the material layer, for instance electronically controlled drilling devices with a coated drilling head.

In a detailed embodiment which is particularly suited with respect to the anti-magnetic properties, the nickel-to-copper ratio in the first component equals to a monel metal and in particular is about 0.7 by 0.3. Alloys being named as monel metals are, by themselves, known in the art and have good anti-magnetic properties with furthermore very small shrinking. This feature is also advantageous for an inventive material in the course of the thermal deposition. Nickel and Copper being present in the ratio of a monel metal does not exclude a presence of further metallic constituents in the first component.

Generally preferred, the first component further comprises a weight portion of boron of less than about 10%. Particularly preferred, the boron share is between about 0.5% and about 6%, in particular between about 1% and about 3%. This share of boron results in a particularly good hardness of the matrix component.

In a particularly preferred embodiment of the invention, in particular in a version with a significant portion of iron in the first component, the boron share is between about 2.5% and about 5.5%.

An advantageous further portion of the first component, additionally or alternatively, is silicon with a weight portion of not more than about 5%, preferred between about 1% and about 2%, particularly preferred about 1.5%. The silicon share in the case of a material in powder form for plasma deposition welding is usually somewhat higher (typical 3%-4%) than in the case of filler wires and electrodes (typical 0.5%-1%).

An advantageous further portion of the first component, additionally or alternatively, is aluminum with a weight portion of not more than about 7%.

An advantageous further portion of the first component, additionally or alternatively, is titanium with a weight portion of not more than about 3%.

An advantageous further portion of the first component, additionally or alternatively, is iron with a weight portion of not more than about 6%, with a simultaneous copper share of more than 10%. Such smaller share of iron can improve the matrix hardness without significantly depleting the anti-magnetic properties.

An advantageous further portion of the first component, additionally or alternatively, is vanadium with a weight portion of not more than about 14%. Furthermore, alternatively or additionally, niobium may be present with a weight portion of not more than about 11%, molybdenum with not more than about 12% and/or tungsten with not more than about 10%.

In a preferred embodiment of the invention, in particular in connection with presence of a significant portion of iron in the first component, the first component contains a weight portion of molybdenum of less than 5%, in particular of not more than about 4%. In a preferred detailed embodiment, the molybdenum share thereby is at least about 1%, in particular at least about 1.5%. By experiments and measurements it has been shown that a certain minimum share of molybdenum further improves the mechanical properties of the matrix (or the deposited first component) which is embedding the hard material, in particular in connection with a high share of iron (nickel-iron-matrix). Though an optimum of the beneficial properties, in particular in the case of high iron shares, is left behind when the molybdenum share is in the region of 5% or more.

An advantageous further portion of the first component, additionally or alternatively, is chrome with a weight portion between about 5% and about 33%.

In the case of a second preferred embodiment of the invention it is provided that the first component contains a weight portion of iron of more than 10%. In order to avoid negative effects in particular with deposition by electric arcs, the iron portion is not more than about 60%, in particular between about 40% and about 60%. In an optimized, advantageous embodiment, the iron portion is between 42% and 48%. Thereby, the weight portion of nickel in the first component is not more than about 70%, in particular between about 40% and about 60%. In an optimized embodiment, the weight portion of nickel in the first component is between about 52% and about 58%. All in all, a significant saving of up to about half of the very costly constituent nickel is achieved hereby, without the deposition of the coating being degraded. In particular a deposition by means of electric arc, e.g. by means of arc welding, is made possible by the remaining high nickel share, without problems arising with an unwanted melting of the second component (hard materials like e.g. tungsten carbide).

For the improvement of the hardness, the first matrix component may preferredly contain a weight portion of boron of less than about 10%. Particularly preferred, the boron share of the first component is between about 0.5% and about 5%, in particular between about 2% and about 3%.

Further advantageously, the first component has a weight portion of silicon of not more than about 5%, preferred between about 1% and about 2%, particularly preferred about 1.5%.

Further shares of in particular metallic constituents may be present in the first component. Preferred, but not terminal, these may be, in each case either cumulative or alternative, aluminum (up to about 7%), vanadium (up to about 14%), niobium (up to about 11%), molybdenum (up to about 12%), tungsten (up to about 10%) or chrome (preferred between 5% and 33%).

In order to assure a particularly good hardness of the matrix it may be provided, according to the respective demands, that the first component has a copper share of less than about 10% additionally to an iron share of more than about 10%.

Although according to the respective demands, a material according to the invention may also have an iron share of more than about 10% as well as a copper share of more than about 10%.

In the case of a particularly preferred embodiment of the invention, the material is objectively provided in the form of a filler wire with the features of claim 49. Advantageously the first component for the generation of the matrix is present in the form of an e.g. tube-shaped jacket of the filler wire. This electrically conducting jacket of the filler wire advantageously envelopes a filler substance, which essentially comprises the second component for the generation of a hard phase. By these means in particular an electrode for arc welding can be provided.

First off all for the use as an expending welding wire, the filler wire may contain a non-metallic additive, in particular in the filler substance. In order to volatilize during the deposition, or at least in order to have a not too big influence on the quality of the deposited layer, the additive preferably has a weight portion of not more than about 2% of the total weight of the filler wire. In a known manner, the additive may contain a binder and/or a salt, or further substances.

Although a filler wire according to the invention will usually contain the major part of the first component in the wire jacket and will usually contain the major part of the second component as a hard material in the filling which is enveloped by the jacket, some constituents of the first component, like for example boron, are regularly mixed into the filling, wherein they are binding into the matrix, which is embedding the hard material, during the deposition.

Generally advantageous the material can be, in the sense of the features of claim 56, provided as an electrode for arc welding. This gives in particular the possibility of a simple deposition of the material at the site of the application, wherein special deposition devices other than an arc welding outfit and its usual accessories are not necessary.

Such electrode may be provided as a wire- or rod electrode. In this context, the material may particularly comprise a binder. Such binders enable or improve the combination of the two components to a wire- or rod electrode. In a particularly preferred embodiment, the electrode is provided as a filler wire electrode, in particular according to one of the claims 49 to 55.

Furthermore the invention comprises a device with a particularly metallic surface according to the features of claim 59. Thereby the material is deposited on the surface as a coating. In the form being deposited on the surface, the hard phase is embedded in the matrix, which predominantly originates from the first component of the material by means of phase transition. The matrix, whose largest singular constituent is nickel, can have, in a respective embodiment, several phases mixed with each other. Regularly the matrix has a high hardness, in particular in the region of 40 HRC and more. Though compared to the “hard phase”, which is originating from the second component, the hardness of the matrix is usually significantly lower. Constituents of the hard phase which are based on tungsten carbide can almost reach the hardness of diamond and therefore predominantly add to the wear resistance of the coating which is deposited on the device.

In a particularly preferred embodiment, the device comprises a drilling head, in particular a drilling head for exploration of oil or gas. Such modern drilling devices in particular for the exploration of commodities can protrude not only vertically or linearly into the depth, but even horizontally. Therefore, the drilling device comprises driving means, control electronics and measurement sensors in close proximity behind the actual, excavating drilling head. These parts may be perturbed by in particular changing magnetic fields, because of which a anti-magnetic conduct of the drilling head, and in particular a coating provided thereon, is desirable. By the inventive use of copper as a main alloy component of the matrix, the wear resistant coating can be held anti-magnetic.

Alternatively, the device may be provided as a coated bottom plate, in particular for tracklaying- or caterpillar vehicles. For example in the field of earth movements or in open pit mining by means of brown coal excavators or similar large equipment it is desirable to protect the bottom plates from intensive wear.

Generally preferred, the device can be a semi-finished product which is brought to its application through further manufacturing steps like for example fastening with screws or fastening by welding.

In a particular preferred embodiment, the coating of the surface is at least partially performed by means of arc welding. Arc welding allows the coating with an inventive material, in particular for maintenance, in particular at the working site of a device like e.g. an exploration drilling machine. In the case of exploration borings this may prevent the need of costly and elaborate transportation of drilling heads, as deposition methods other than arc welding usually are not available at such sites.

The object of the invention is further achieved by a method with the features of claim 64. Thereby a material according to the invention is melted and deposited onto a surface in order to achieve a wear protection of the surface. In a preferred embodiment, the melting and depositing is done by means of arc welding, in particular by means of a filler wire electrode. A deposition by means of arc welding is especially location-independent and cost-effective, an easy training of the personnel depositing the material being possible furthermore.

Further advantages and features of the invention conclude from the embodiments described hereinafter as well as from the dependent claims.

Subsequently, several preferred embodiments of the invention are described and further explained by the enclosed drawing.

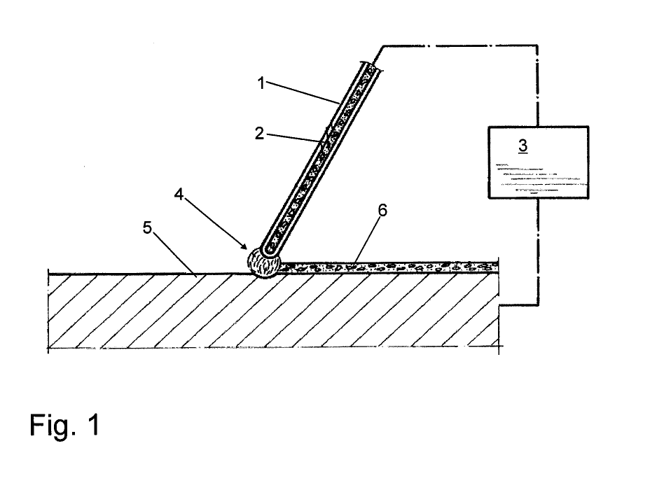

FIG. 1 shows a filler wire according to the embodiments of the invention.

In the case of a first preferred embodiment of the invention, an inventive material comprises components and portions as follows, wherein portions are in weight-% in each case:

First component (weight portion of the material 50%):
60%-65% nickel;
30%-35% copper, wherein the copper share with respect to the nickel share is like a monel metal,
2% iron;
1%-2% boron.

Second component (weight portion of the material 50%):
broken or spherical two phase tungsten carbide (“WSC”) as a hard material. The grain size of the WSC is adapted according to the respective demands. The WSC can contain in particular cobalt or also other elements as an alloyed additive in a known manner;
small amounts (0.1%-2% share of the total weight of the material) of additives like e.g. salts or binders, in particular for improving the properties in the course of deposition by means of arc welding.

The material according to the first embodiment is provided as a filler wire (FIG. 1). Thereby a tube 1 is manufactured from the homogenous metallic material of the first component, in particular the tube being lock-seamed alongside. Dependent on the embodiment as a rod or a wire, the tube is filled with the second component 2 after or during its manufacturing. By means of arc welding with an electrical energy source 3 the filler wire is molten in an electric arc 4 and deposited onto a work piece 5 which is to be coated. In particular with this kind of deposition, at least in the case of tungsten carbide as a hard material, it is desirable that the second component, being present in the form of particles, is not molten, but the particles being embedded in the deposited coating 6 as intact as possible within the molten and re-solidified matrix.

A material or filler wire according to the first embodiment provides a material for a particularly anti-magnetic coating of a surface. The coating is made by thermal phase transition, in particular by means of arc welding. In doing so, the filler wire, which as a whole forms the material, is used as an depositing expending electrode of an arc welding outfit.

This anti-magnetic coating for wear protection is deposited onto a drilling head for exploration-boring of commodities. Such drilling heads regularly comprise roller bits which are provided with a particularly hard coating. The deposition by means of arc welding is in particular performed for the purpose of repair and maintenance of worn drilling heads at the site of the boring.

In the case of a second preferred embodiment of the invention, an inventive material comprises components and portions as follows, wherein portions are in weight-% in each case:

First component (weight portion of the material 50%):
60%-65% nickel;
42%-48% iron;
2%-3% boron.

Second component (weight portion of the material 50%):
broken or spherical two phase tungsten carbide (“WSC”) as a hard material. The grain size of the WSC is adapted according to the respective demands. The WSC can contain in particular cobalt or also other elements as an alloyed additive in a known manner;
small amounts (0.1%-2% share of the total weight of the material) of additives like e.g. salts or binders, in particular for improving the properties in the course of deposition by means of arc welding.

Two phase tungsten carbide (“WSC”) is understood as e.g. a material wherein tungsten and a special graphite are mixed and brought into a crucible. The mixture is then molten at very high temperatures of e.g. 3000° C. and above, cast into graphite moulds and cooled down very rapidly. The resulting WSC is then being ground, broken or processed to the desired particle form by other means.

Macrocrystalline tungsten carbide, occasionally also named as monocrystalline tungsten carbide, is understood as a material wherein tungsten carbide crystals are produced out of a matrix, e.g. an iron- or cobalt matrix, in a chemical process.

WSC as well as macrocrystalline tungsten carbide differ from conventional tungsten carbide, which is first mixed, ground and pressed and then sintered, by their especially good stability concerning a melting of the particles in the course of deposition onto a work piece by means of arc welding or other methods.

The material of the second embodiment is characterized by its especially cost effective production compared to a mere nickel matrix, while well keeping its abrasive and corrosive properties. It is suited for the deposition by means of arc welding, in particular in the form of a filler wire (see description of the first embodiment and FIG. 1).

In the case of a third preferred embodiment of the invention, also a high share of iron together with nickel is present in order to save significant costs compared to a mere nickel matrix at a comparable quality:

First component (weight portion of the material 50%):
1%-4%molybdenum;
2%-5.5% boron;
rest nickel and iron in a ratio (Ni:Fe) between 48:52 and 55:45.

Second component (weight portion of the material 50%):
broken or spherical two phase tungsten carbide (“WSC”) as a hard material. The grain size of the WSC is adapted according to the respective demands. The WSC can contain in particular cobalt or also other elements as an alloyed additive in a known manner;
small amounts (0.1%-2% share of the total weight of the material) of additives like e.g. salts or binders, in particular for improving the properties in the course of deposition by means of arc welding.

Here again the material is present in the form of a filler wire according to FIG. 1, wherein the first component forms essentially the jacket 1 of the filler wire and the second component and eventually the additives are forming the filling 2. Some constituents of the first component which form the matrix like e.g. boron are contained as an addition in the filling substance.

A further embodiment of the invention is also formed as a filler wire according to FIG. 1 and comprises the components as follows:

An alloyed band for forming the jacket of the filler wire, consists of
51% Ni,
48% Fe,
0.5% Mn, and
0.1% Si.

All constituents of the jacket of the filler wire belong to the frist component.

A powder for filling the filler wire consists of
5.5% boron (belonging to the first component)
2.5% NaF-silicate (additive, in particular for improvement of the properties during arc-welding)
92% two phase tungsten carbide and/or macrocrystalline tungsten carbide.

The weight ratios of jacket and filling depend, in certain ranges, on dimension and form of the filler wire. With a wire diameter of 1.6 mm the weight of the filling is preferably about 50%-54%. With a wire diameter of 2.4 mm the weight of the filling is preferably about 58%-62%.

In the case of a further embodiment of the invention, the material is present as a powder for plasma deposition welding. The first component (matrix) comprises the constituents as follows:
52% Ni,
3.0%-3.2% Si,
3.0%-3.2% boron,
rest Fe (about 42%).

The second component consists of two phase tungsten carbide and/or macrocrystalline tungsten carbide. Its weight portion of the total amount of the powder is between about 30% and about 70%, in particular about one half.

It is to be understood that the features of the individual embodiments may be combined with each other.

1. A material for the coating of a surface by means of at least partial thermal phase transition, comprising
a first component with several metallic constituents for the generation of a matrix, and
a second component for the generation of a hard phase being embedded in the matrix,
wherein the first component, with respect to its total weight, has a share of Nickel of at least about 40%,
wherein the second component has a share of between about 20% and about 80% of the total weight of the material,
wherein
the first component has a share of at least about 10%, in particular at least about 20%, of a further metal from the group copper or iron,
wherein
the second component consists of a hard material,
wherein the hard material is at least partially, in particular predominantly present in the form of two phase tungsten carbide (WSC), or
wherein the hard material is at least partially, in particular predominantly present in the form of macrocrystalline tungsten carbide, or
the hard material is at least partially present as a vanadium carbide in particle form,
or that the material comprises vanadium and carbon in order to generate vanadium carbide in the hard phase.

2-13. (canceled)

14. The material as claimed in claim 1, wherein the first component contains a weight portion of boron of less than about 10%.

15. The material as claimed in claim 14, wherein the boron share is between about 0.5% and about 6%, in particular between about 1% and about 3%.

16-21. (canceled)

22. The material as claimed in claim 1, wherein the first component has a weight portion of vanadium of not more than about 14%.

23. The material as claimed in claim 1, wherein the first component has a weight portion of niobium of not more than about 11%.

24. The material as claimed in claim 1, wherein the first component has a weight portion of molybdenum of not more than about 12%.

25-26. (canceled)

27. The material as claimed in claim 1, wherein the first component has a weight portion of tungsten of not more than about 10%.

28. The material as claimed in claim 1, wherein the first component has a weight portion of chrome of between about 5% and about 33%.

29. (canceled)

30. The material as claimed in claim 1, wherein the first component has a weight portion of iron of more than 35%, in particular of more than 37%.

31. The material as claimed in claim 30, wherein the weight portion of iron is not more than about 50%, in particular between about 40% and about 50%.

32. (canceled)

33. The material as claimed in claim 30, wherein the weight portion of nickel in the first component is not more than about 70%, in particular between about 40% and about 60%.

34-43. (canceled)

44. The material as claimed in 30, wherein the first component has a weight portion of chrome of between about 5% and about 33%.

45-48. (canceled)

49. The material as claimed in claim 1, in combination with a filler wire comprising a jacket and a filler substance enveloped by the jacket, wherein the filler wire comprises the material.

50-55. (canceled)

56. The material as claimed in claim 1, in combination with an electrode for electric arc welding, wherein the electrode comprises the material.

57-58. (canceled)

59. The material in combination with a device, wherein the device comprise a metallic surface, wherein the surface is coated with the material.

60. The combination as claimed in claim 59, wherein the device comprises a drilling head for exploration of oil and gas.

61. The combination as claimed in claim 59, wherein the device comprises a coated bottom plate for tracklaying or caterpillar vehicles.

62. The combination as claimed in claim 59, wherein the device is a semi-finished product which is coated with the material.

63. The combination as claimed in claim 59, wherein the coating of the surface has at least partially been performed by means of arc welding.

64. A method for depositing a hard layer on a surface, comprising melting and depositing onto the surface of the material as claimed in claim 1.

65. The method as claimed in claim 64, wherein the melting and depositing of the material onto the surface is performed by electric arc welding with a filler wire electrode.
